(19) United States
(12) Patent Application Publication
(10) Pub. No.: US 2005/0194211 A1
(43) Pub. Date: Sep. 8, 2005

(54) Footholds for fall protection devices

(76) Inventors: James E. O'Shall, Polk, PA (US); Jeffrey G. LeMier, Franklin, PA (US); John R. Frey, Franklin, PA (US); David C. Puleo, Oil City, PA (US); David G. Hoffman, Seneca, PA (US); Philip D. Cozad, Cranberry, PA (US); Charles A. Ziegler, Franklin, PA (US)

Correspondence Address: BARTONY & HARE, LAW & FINANCE BUILDING, SUITE 1801, 429 FOURTH AVENUE, PITTSBURGH, PA, 15219, US

(21) Appl. No.: 11/072,662

(22) Filed: Mar. 4, 2005

Related U.S. Application Data
(60) Provisional application No. 60/550,424, filed on Mar. 5, 2004.

(51) Int. Cl. A62B 35/00

(52) U.S. Cl. 182/3

(57) ABSTRACT

A foothold system for attachment to a fall protection device includes at least one foot upon which a user can rest a foot and an attachment member in operative connection with the foot seating. The attachment member is adapted to attach to the fall protection device (for example, a safety harness, a safety belt or a lanyard).

### CROSS-REFERENCE TO RELATED APPLICATION

The present application claims the benefit of U.S. Provisional Patent Application Ser. No. 60/550,424, filed Mar. 5, 2004, the disclosure of which is incorporated herein by reference.

### FIELD OF THE INVENTION

The present invention relates generally to footholds for use with fall protection devices including, for example, safety harnesses, safety belts and lanyards), to safety harness systems incorporating footholds and to methods of attaching footholds to fall protection devices. The present invention relates particularly to foothold safety devices that can be attached to or retrofitted to safety harnesses and other fall protection devices, to safety harness systems incorporating such foothold safety devices and to methods of attaching such foothold safety devices to safety harnesses.

### BACKGROUND OF THE INVENTION

References set forth herein may facilitate understanding of the present invention or the background of the present invention. Inclusion of a reference herein, however, is not intended to and does not constitute an admission that the reference is available as prior art with respect to the present invention.

Safety harnesses are commonly used as part of a fall protection system for persons subjected to the potential of a fall from a height. In the workplace, full-body safety harnesses are generally used. Such harnesses, which typically include both an upper torso portion (having, for example, shoulder straps) and a lower torso portion (having, for example seat straps and leg straps), can be designed in many alternative manners.

Many currently available full-body safety harnesses are manufactured from relatively inelastic, woven webbing materials such as nylon or polyester. A flexible and elastic harness, as described in U.S. Pat. No. 6,006,700, assigned to the assignee of the present invention, the disclosure of which is incorporated herein by reference, has been introduced that greatly improves the comfort of the user during normal use of the safety harness. A safety harness with blunted edges for further increasing the comfort of the user is disclosed in U.S. Pat. No. 6,739,427, assigned to the assignee of the present invention, the disclosure of which is incorporated herein by reference.

Although the comfort of safety harnesses during normal use and even during a fall arrest has been greatly improved in the above-described harnesses, problems can still arise in the case that a harness user is suspended in a safety harness for a substantial period of time after a fall. In that regard, orthostatic intolerance/suspension trauma, including unconsciousness and even death, may be experienced by an individual using a fall protection safety harness or belt if the individual remains suspended in the harness or belt for a length of time. Typically, a person suspended in a fall protection system is suspended in an upright static position in which venous pooling can lead to orthostatic intolerance/suspension trauma. Venous pooling and orthostatic intolerance can lead to a serious injury and even death as the brain and other vital organs are deprived of oxygen.

For the above reasons, it is recommended that individual in a safety harness should not work alone, and, in the case of suspension after a fall, the suspended individual should be rescued as soon as possible. It is further recommended, for example, that an individual using a harness be trained to try to move their legs while suspended in the harness and to push against any available footholds in an attempt to prevent venous pooling. However, suitable footholds are generally not available.

It is an object of the present invention to provide footholds that can readily and inexpensively be incorporated into safety harnesses.

### SUMMARY OF THE INVENTION

In one aspect, the present invention provides a foothold system for attachment to a fall protection device. The foothold system includes a foot seating upon which a user can rest at least one foot and an attachment member in operative connection with the foot seating. The attachment member is adapted to attach to the fall protection device (for example, a safety harness, a safety belt or a lanyard). The distance between the attachment member and a bottom of the foot seating can be adjustable to, for example, accommodate users of different size.

The attachment member can, for example, be adapted to attach to a fall protection safety harness after manufacture of the safety harness is complete. The attachment member can, for example. be a loop attached at an end of the foothold system through which at least a portion of the foothold system (for example, the foot seating) can be passed or doubled back.

In one embodiment, the foot seating is a foot loop operativley attached to the end of an extending strap. At an opposite end of the extending strap, the extending strap is in operative attachment to the attachment member. The length of the extending strap between the attachment member and the foot loop can be adjustable to accommodate users of different size. The length of the strap can, for example, be adjustable via a buckle mechanism. As described above, the attachment member in this embodiment can be a loop through which the foot loop and extending strap can be doubled back and choked off.

At least a portion of the foothold system can, for example, be compacted (for example, folded over itself or otherwise compacted) to reduce the overall size (for example, length and/or width) of the foothold system prior to deployment of the foothold system. The foothold system can include a container, cover or sleeve into which at least a portion of the foothold system (for example, a portion of the extending strap and the foot loop in several embodiments) is compacted. In certain embodiments, the foothold system can further include at least one retaining member or strap to hold the foothold system in close proximity to a strap of a safety harness or other fall protection device prior to deployment of the foothold system.

In another aspect, the present invention provides a safety harness system including: at least one foothold system including at least one foot seating upon which a user can rest at least one foot and an attachment member an attachment member in operative connection with the foot seating. The attachment member is adapted to attach to a safety harness of the safety harness system. The safety harness includes at least one strap portion for extending over a portion of the person's body to retain the person within the safety harness.

In a further aspect, the present invention provides a method of incorporating a foothold system into a fall protection device, including the step: attaching the foothold system to the fall protection device after manufacture of the fall protection device is complete. As described above, the foothold system can include: a foot seating upon which a user can rest at least one foot and an attachment member in operative connection with the foot seating. The attachment member is adapted to attach the foothold system to the fall protection device. The fall protection device can, for example, be a safety harness which includes at least one strap portion for extending over a portion of the person's body to retain the person within the safety harness. The attachment member can, for example, be an attachment loop, and the step of attaching the foothold system to the strap of the safety harness can include the step of passing at least a portion of the foothold system (for example, at least a portion of a foot loop and an extending strap in several embodiments) through the attachment loop.

In another aspect, the present invention provides a fall protection system including a fall protection device used to suspend a user in the case of a fall; and at least one foothold system. the foothold system includes: a foot seating upon which a user can rest at least one foot and an attachment member in operative connection with the foot seating. The attachment member is adapted to attach the foothold system to the fall protection device.

In still a further aspect, the present invention provides a method of facilitating leg movement of a person suspended in a fall protection harness, including: deploying a foothold system attached to the fall protection harness from a compacted state to an uncompacted state after a fall; and placing at least one foot of the person into a foot seating of the foothold system after deployment of the foothold system. The method can further include the step of attaching the foothold system to the fall protection harness before the fall. As described above, in one embodiment, the foothold system is attached to the safety harness using an attachment member comprising a loop attached at an end of the foothold system through which at least a portion of the foothold system can be passed or doubled back and subsequently choked off or tightened.

In still another aspect, the present invention provides a fall protection system including a fall protection device used to suspend a user in the case of a fall and at least one foothold system. The foothold system includes a foot seating into which a user can insert a foot and an attachment member in operative connection with the foot seating, The attachment member is adapted to attach to the fall protection device. The foothold system is adapted to be compacted to reduce the overall size thereof.

In general, the present invention provides a safety device or system that allows an individual (who may be suspended in or by, for example, a safety harness, belt and/or lanyard after a fall) to, for example, relieve pressure on portions of the body. Furthermore, the present invention provides foothold safety devices that enable muscle contraction in the lower extremities. Such muscle contractions are an important factor in maintaining blood pumping/circulation and reducing the risk of venous pooling. The ability to relieve pressure and contract the muscles of the lower extremities while suspended is critical in providing comfort and in reducing venous pooling that typically occurs in the legs as a result of the force of gravity and a lack of movement. The foothold systems of the present invention thereby reduce the risk of orthostatic intolerance/suspension trauma. The foothold systems of the present invention can be designed to be adaptable to, for example, any safety harness, safety belt or lanyard already in use, and are easily affixed to any such fall protection device by, for example, looping it through or around a portion thereof. The foothold systems of the present invention can also be incorporated into a new safety harness or other fall protection device as part of the manufacturing process. The foothold systems of the present invention can also be small, compact, and designed to fit snugly against, for example, the webbing of a harness. The compact or small size and snug fit of the foothold systems of the present invention reduce or eliminate the risk that the foothold systems will interfere with a users work activities. The foothold systems of the present invention can, for example, be located in the lower front portion of a safety harness where the foothold system is visible and readily accessible by a person suspended in the harness after a fall. The foothold systems can be easily deployed either manually or automatically by, for example, applying force to a portion of the foothold system which releases the foothold system for deployment.

### BRIEF DESCRIPTION OF THE DRAWINGS

FIG. 1A illustrates a currently available full body safety harness.

FIG. 1B illustrates an embodiment of a foothold system of the present invention attached to the safety harness of FIG. 1A.

FIG. 1C illustrates an enlarged view of the foothold system of FIG. 1B in a closed, folded or compacted storage/standby state.

FIG. 1D illustrates an enlarged view of the foothold system of FIG. 1B in an open, unfolded or extended deployment state.

FIG. 1E illustrates an enlarged view of a portion of the harness of FIG. 1A illustrating the attachment of a foothold system of the present invention thereto.

FIG. 2 illustrates a user wearing the safety harness of FIG. 1A with foothold systems of the present invention attached thereto.

FIG. 3 illustrates suspension of the user in the safety harness and deployment of the foothold systems of the present invention with the user in a crouched position.

FIG. 4 illustrates the user of FIG. 4 pushing against the foot loops of the foothold systems of the present invention to obtain an upright or standing position.

FIG. 5A illustrates another embodiment of a foothold system of the present invention in a closed, folded or compacted storage/standby state.

FIG. 5B illustrates another view of the foothold system of FIG. 5A in a closed, folded or compacted storage/standby state.

FIG. 6 illustrates the foothold system of FIG. 5A in a partially deployed state, indicating the manner in which the foothold system is folded or compacted.

FIG. 7A illustrates a user of a safety harness standing upon a surface wherein two foothold systems as illustrate in FIGS. 5A through 6 have been attached to the safety harness.

FIG. 7B illustrate the user of FIG. 7B suspended in the safety harness after a fall.

FIG. 7C illustrates the user beginning the deployment of one of the foothold systems.

FIG. 7D illustrates the user in the process of inserting the left foot of the user into the foothold system connected to the right side of the safety harness.

FIG. 7E illustrate the left foot of the user in the foot loop of the foothold system connected to the right side of the safety harness.

FIG. 7F illustrates the user in the process of inserting the right foot of the user into the foothold system connected to the left side of the safety harness.

FIG. 7G illustrates the left foot of the user in the foot loop of the foothold system connected to the right side of the safety harness and the right foot of the user in the foot loop of the foothold system connected to the left side of the safety harness.

### DETAILED DESCRIPTION OF THE INVENTION

Representative embodiments of the foothold systems of the present invention are discussed herein as attached to a full body safety harness. One skilled in the art appreciates, however, that the foothold systems of the present invention are readily incorporated into or attached to other fall protection devices such as safety belts and lanyards.

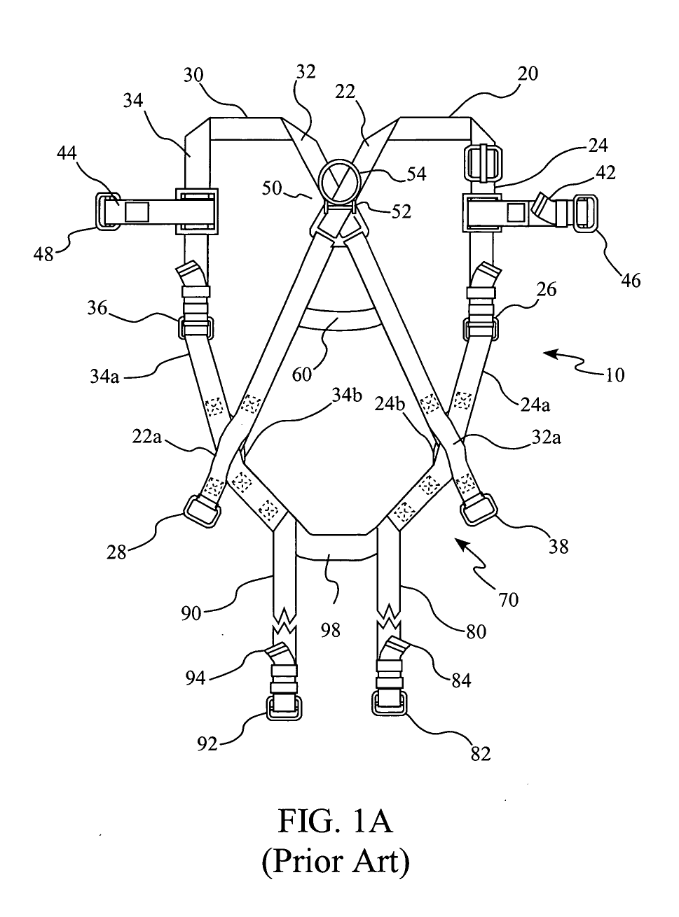

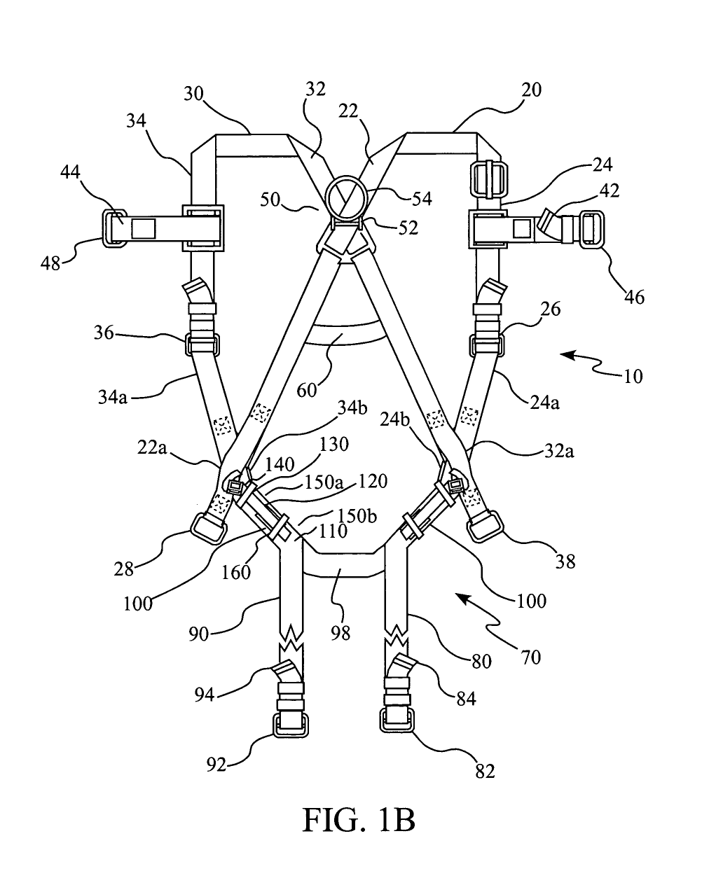

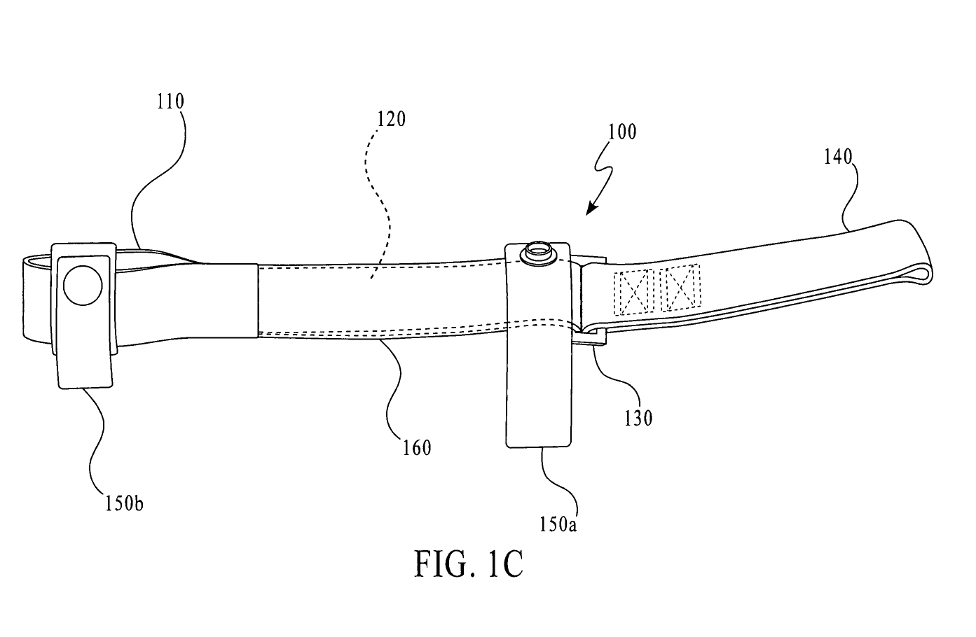

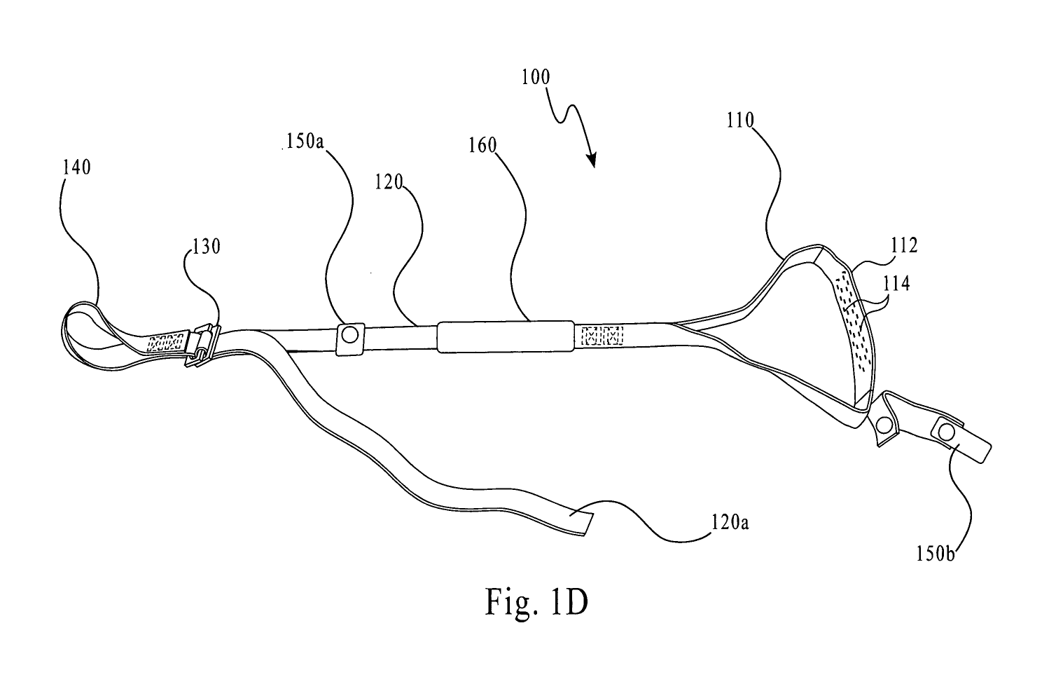

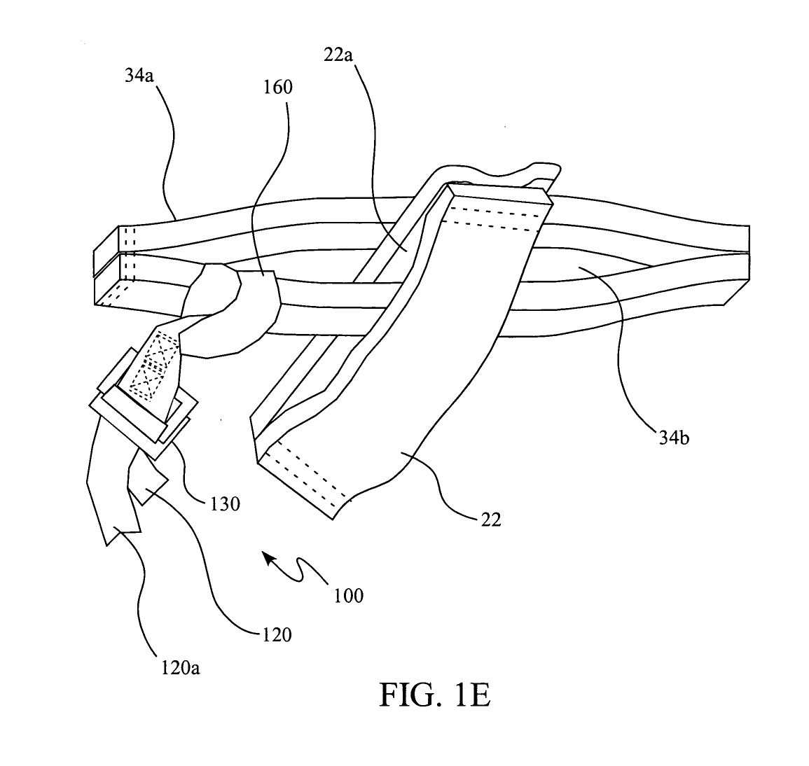

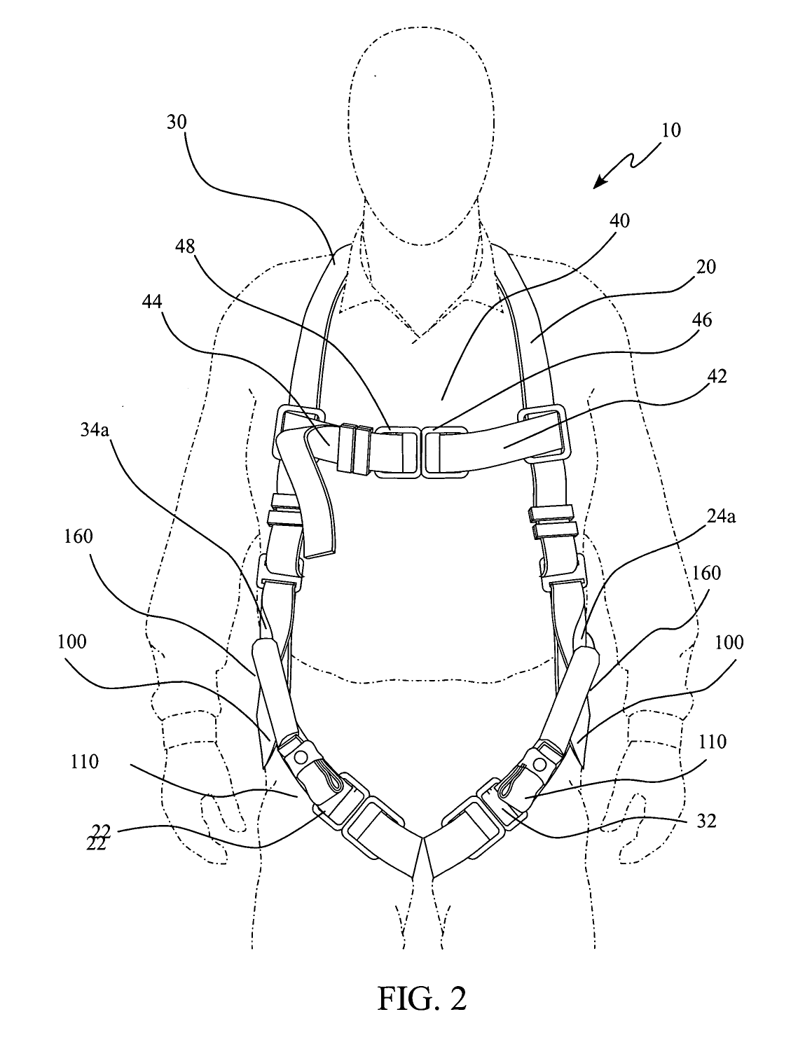

FIG. 1A illustrates an embodiment of a full-body safety harness 10 of the present invention. The overall structural design of safety harness 10 corresponds generally, for example, to the DURAFLEX® safety harness available from Bacou-Dalloz Fall Protection, Inc. of Franklin, Pa. Such safety harnesses are disclosed, for example, in U.S. Pat. Nos. 6,006,700 and 6,739,427. Safety harness 10 includes an upper torso portion comprising first and second shoulder straps 20 and 30 for extending over the shoulders of the user and a multi-component chest strap 40 (see, for example, FIG. 2 for a view of assembled chest strap 40) for extending over a portion of the chest of the user.

A first end of each of shoulder straps 20 and 30 extends down over the back of the user to form first and second generally longitudinal back straps 22 and 32, respectively. Longitudinal back straps 22 and 32 of shoulder straps 20 and 30 cross through and connect to a typical D-ring 54 as known in the art. D-ring 54 includes a harness connection portion 52 and an anchor portion 54. Harness connection portion 52 enables fastening of D-ring 54 to safety harness 10 via longitudinal back straps 22 and 32. Anchor portion 54 is adapted to be connected to a nylon rope, a chain, webbing, a self retracting lifeline or other connector which is be used to anchor the person wearing safety harness 10.

In the embodiment of FIG. 1A, after crossing and passing through D-ring 54, shoulder straps 20 and 30 are connected via a generally latitudinal back strap 60. Latitudinal back strap 60 passes generally latitudinally over a portion of the back of the user.

A second end of each of shoulder straps 20 and 30 extends downward over the front of the user to from generally longitudinal first and second front straps 24 and 34, respectively. A first chest strap portion 42 is preferably attached to front strap 24 and a second chest strap portion 44 is attached to front strap 34. Each of first and second chest straps 42 and 44 have cooperating fastening members 46 and 48 on the ends thereof to enable attachment of first and second chest straps 42 and 44 to form chest strap 40. As known in the art, first and second chest straps 42 and 44, respectively, are preferably attached via an adjustable mating or quick connect buckle mechanism, including, for example, cooperating fastening members 46 and 48.

First and second front straps 24 and 34 extend further downward and preferably include adjustment members 26 and 36 (for example, adjustable buckles) as known in the art for adjustment of the fit of safety harness 10 on the upper torso of the user. Extending still further downward as illustrated in FIGS. 1A and 1B, extensions 24a and 34a of first and second front straps 24 and 34 converge and, in connection with several other components of safety harness 10 as described below, form a seat portion or subpelvic portion 70. First and second front extension straps 24a and 34a pass to the rear of the user and seat portion 70 passes under the seat of the user.

Attached to and extending from seat portion 70 are a first and a second leg strap 80 and 90, respectively. Each of first and second leg straps 80 and 90 pass around the upper leg of the user to be attached to the distal end of first and second longitudinal back straps 22 and 32, respectively. The distal ends of each of first and second leg straps 80 and 90 and the distal ends of each of longitudinal back straps 22 and 32 thus preferably comprise cooperating fastening members (82 and 92 and 28 and 38, respectively) such as adjusting buckle members as known in the art.

In the embodiment of FIG. 1A, back strap 22 passes through buckle 28 and then is doubled back on itself to form a loop 22a. As know in the art, back strap 22 includes regions of stitching to maintain back strap 22 in doubled connection and to form loop 22a. Similarly, back strap 32 passes through buckle 38 and then is doubled back on itself to form a loop 32a.

The bottom portion of safety harness 10 can, for example, be fabricated via a first length of material (for example, inelastic webbing material as described above) which begins at first end 94 on leg strap 90. The material travels downward through fastening member 92 and then travels upward toward seat portion 70, thereby forming leg strap 90. Upon reaching seat portion 70, the material travels along the path identified by the lower portion of strap 34a, and is sewn to the back side thereof. The material is stitched to the back side of strap 34a to form a loop 34b. Similarly, a second length of material (for example, inelastic webbing material as described above) begins at first end 84 on leg strap 80. The material travels downward through fastening member 82 and then travels upward toward seat portion 70, thereby forming leg strap 80. Upon reaching seat portion 70, the material travels along the path identified by the lower portion of strap 24a, and is sewn to the back side thereof. The material is stitched to the back side of strap 24a to form a loop 34b. As illustrated in FIGS. 1A, 1B and 1E, loops 34b and 22a are interconnected, and loops 24b and 32a are interconnected. A third length of material is sewn between leg straps 80 and 90 to form center portion 98 of seat portion 70 and connect the left and right halves of the lower portion of harness 10.

In FIG. 1B, safety harness 10 has been retrofitted with a foothold system 100 to provide a foothold should the user of the safety harness 10 be suspended after a fall. In the foothold systems of the present invention a foothold such as a loop of material is attached to a fall protection devices such as a full body safety harness. In the embodiment of FIGS. 1B through 4, foothold system 100 is readily attachable to (and removable from) virtually any safety harness, enabling simple retrofitting of existing harnesses to provide a self-contained foothold in the case of a fall. To more readily retrofit existing safety harnesses, foothold system 100 can be readily attachable to a safety harness after complete manufacture/assembly of the safety harness. In that manner, currently manufacturing practices need not be altered for use in connection with the foothold systems of the present invention. Indeed, foothold system 100 of the present invention can be readily attachable to a safety harness (or other fall protection equipment) by a user in the field. Preferably, the foothold systems of the present invention are attachable to a safety harness in the field (for example, by the user thereof) without the use of tools.

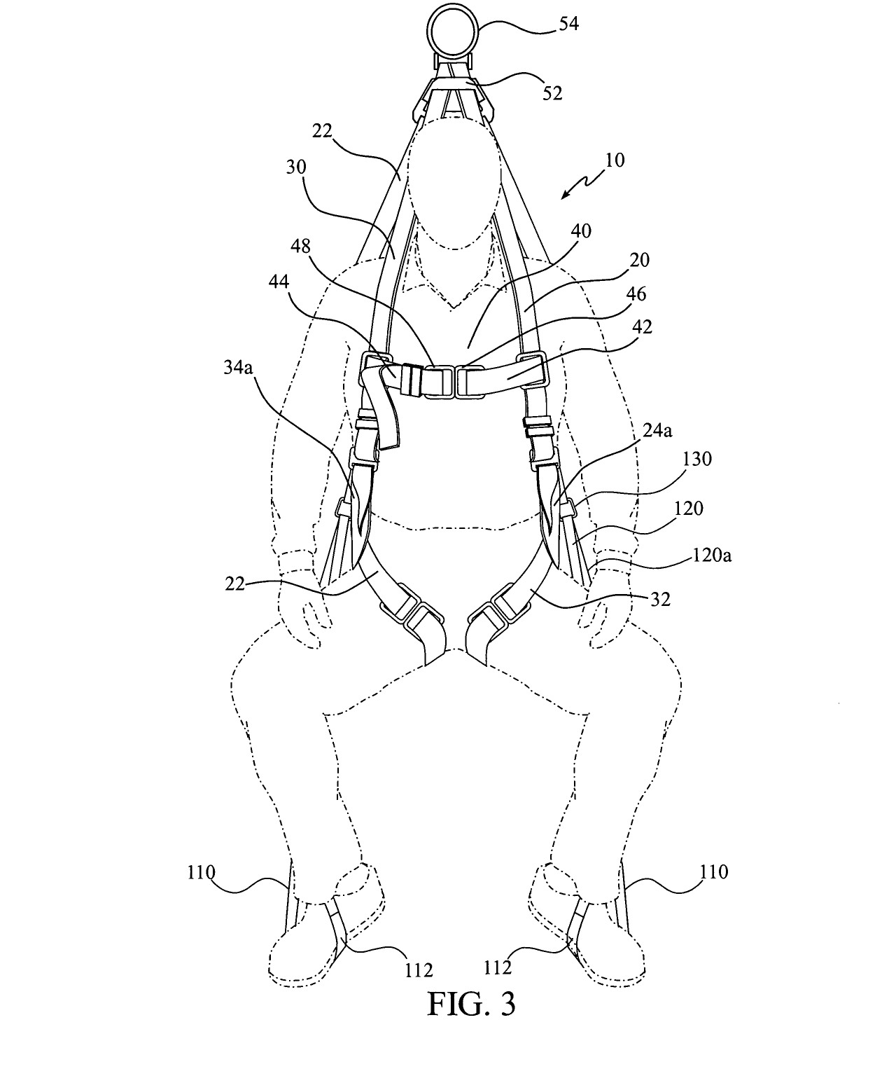

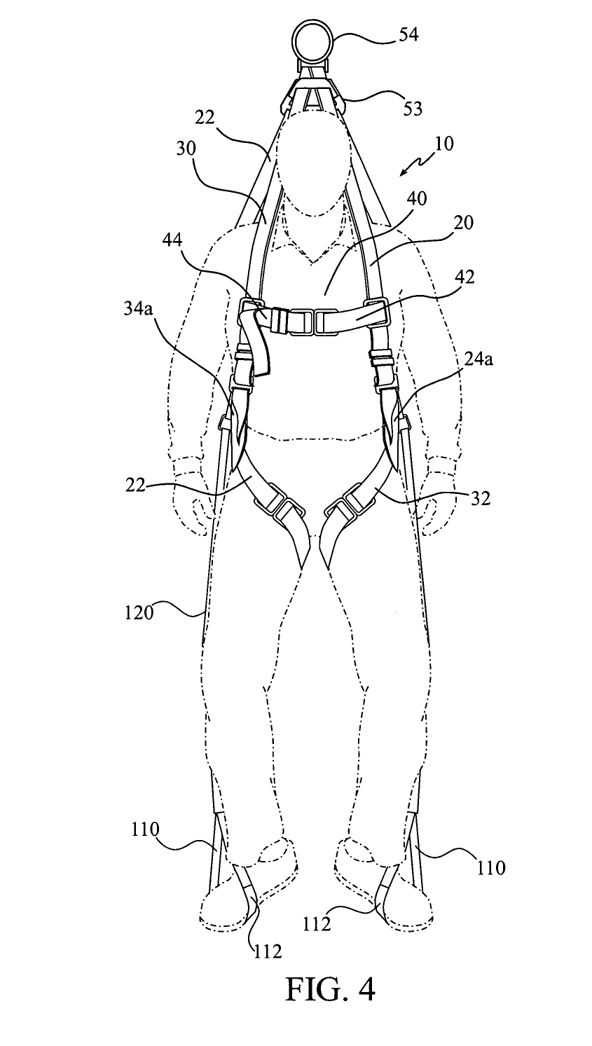

As illustrated, for example, in FIGS. 1B through 1E, in one embodiment, foothold system 100 includes a foothold such as a foot loop or stirrup 110 in which or upon which the user of foothold system 100 places or rests the user's foot in the case of suspension after a fall (see, for example, FIGS. 3 and 4). Foot loop 100 can, for example, be formed or assembled in a manner that foot loop 110 tends to remain in an open position (see FIG. 1E) rather than closing or collapsing under its own weight (after deployment) to facilitate a user placing the user's foot within foot loop 110. As illustrated in FIG. 1E, foot loop 110 can be kept in an expanded or open position after deployment of foothold system 100 by providing an extending or sleeve portion 114 that extends across the bottom or lower portion of foot loop 110. In the embodiment of FIG. 1E, sleeve portion 114 is a length of generally tubular or cylindrical webbing material that encompasses the bottom portion of foot loop 110 and is sewn into place. One or more flexible extenders 112 (for example, a length of a flexible polymeric material) can be placed in sleeve 114 to prevent sleeve 114 from folding under its own weight once foothold system is deployed, thereby keeping foot loop 110 in an open position for insertion of a foot. Flexible extenders 112 can have flexibility suitable to allow compacting (for example, folding, rolling etc.) of foot loop 110 (including sleeve 114) for storage (as described above) while being suitably stiff to maintain foot loop 110 in an open state after deployment (as also described above).

Foot loop 110 can be place in operative connection with or attached to (for example, as a separate component or by being formed integrally with) an extending length of generally inelastic strapping material 120 (for example, nylon) that can be adjustable in length (to accommodate different leg lengths of individual users) via, for example, a buckle system 130 as known in the art. Unlike the strapping material of safety harness 10 (which must have an ultimate tensile load sufficiently high to withstand the forces in a fall arrest—typically at least 5000 pounds in the United States), the components and material of foothold system 100 of the present invention do not experience the large forces of a fall. The components and materials for the foothold systems of the present invention need only support the weight of a user of safety harness 10 after a fall has been arrested. For example, an ultimate tensile load in the range of approximately 300 to 600 pounds can be sufficient for such materials. Examples of a suitable materials for use in the foothold systems of the present invention are relatively thin nylon or polyester webbing materials. In one embodiment, 1 inch wide, relatively thin webbing material was used. As clear to one skilled in the art, many materials are suitable for use in the present invention.

Foothold system 100 is preferably attachable to existing safety harnesses via an attachment member 140, which in the embodiment of FIGS. 1B through 1E is a simple loop of material through which the opposite end (that is, the foot loop end) of foothold system 100 is looped, doubled back or passed through (to “choke off” or to tighten foothold system 100 on itself) to attach foothold system 100 to a safety harness. As clear to one skilled in the art, other attachment mechanisms (including, for example, buckles and like fasteners) can be used to attach the foothold systems of the present invention to safety harnesses. Attachment loop 140 enables foothold system 100 to be readily and quickly attached to virtually any existing safety harness by, for example, a user of the safety harness in the field or by a safety director upon distribution of the safety harness. In this embodiment, no disassembly of safety harness 10 or other fall protection device is required to attach foothold system 100 thereto. Likewise, no tooling is required to attach foothold system 100 to safety harness 10.

Prior to attachment to safety harness 10 and after attachment to safety harness 10, but prior to deployment after a fall, foothold system 100 is preferably compact and does not dangle away from safety harness 10. In the embodiment of FIGS. 1B through 1E, foothold system 100 includes snap fasteners 150a and 150b near the ends thereof to maintain foothold system 100 in close connection with a strap of safety harness 10 before deployment of foothold system 100. To deploy foothold system 100, snap fasteners 150a and 150b are simply disconnected or unsnapped to allow foothold system 100 to swing away from the strap of safety harness 10 about attachment loop 140. Snap fasteners 150a and 150b can remain attached to foothold system 100 after deployment of foothold system 100 in the case of suspension after a fall. In the embodiment of FIGS. 1B through 1E, foothold system 100 further includes a storage cover, container or sleeve 160 in which at least a portion of extending strap 120 and at least a portion of foot loop 110 are folded or otherwise compacted before deployment of foothold system 100. During deployment of foothold system 100, the user can, for example, simply pull the foot loop end of extending strap 120 to extend, remove or unfold extending strap 120 and foot loop 110 from sleeve 160. Storage sleeve 160 can, for example, remain in connection with the extended strap 120 as illustrated, for example, in FIG. 1D. After deployment, the user can, for example, pull on end 120a to adjust the length of extending strap 120 (via buckle 130) to accommodate the length of the user's legs.

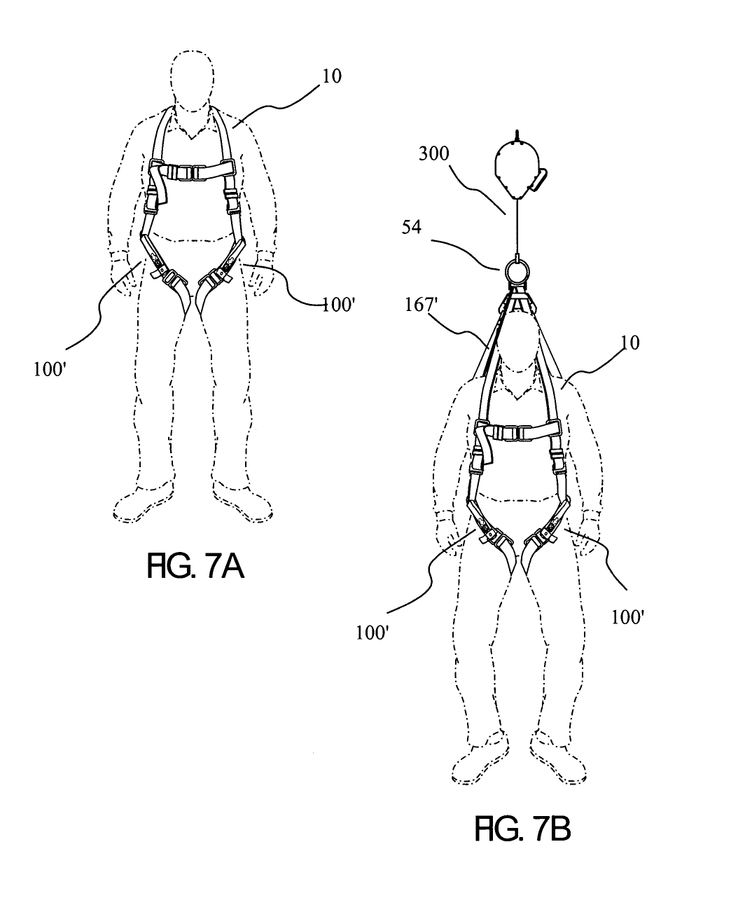

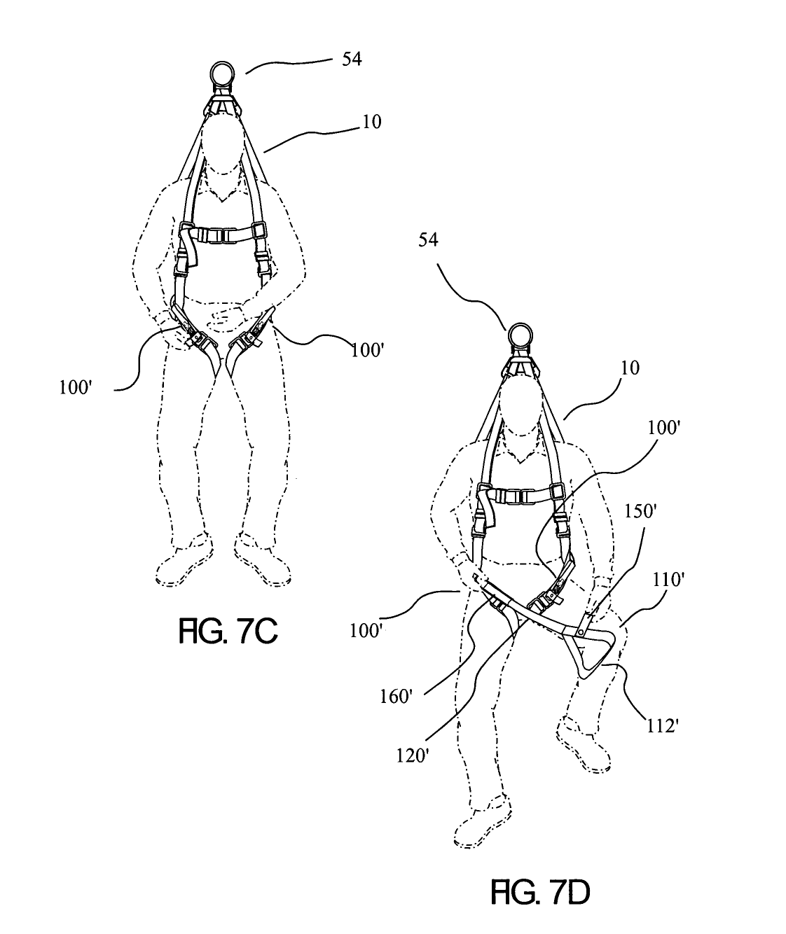

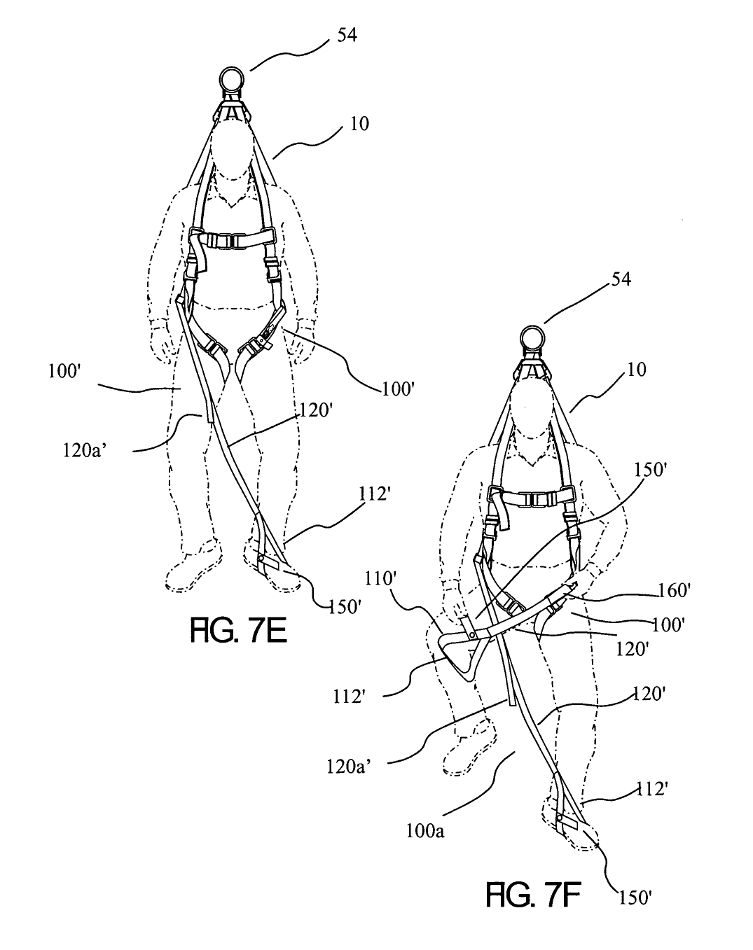

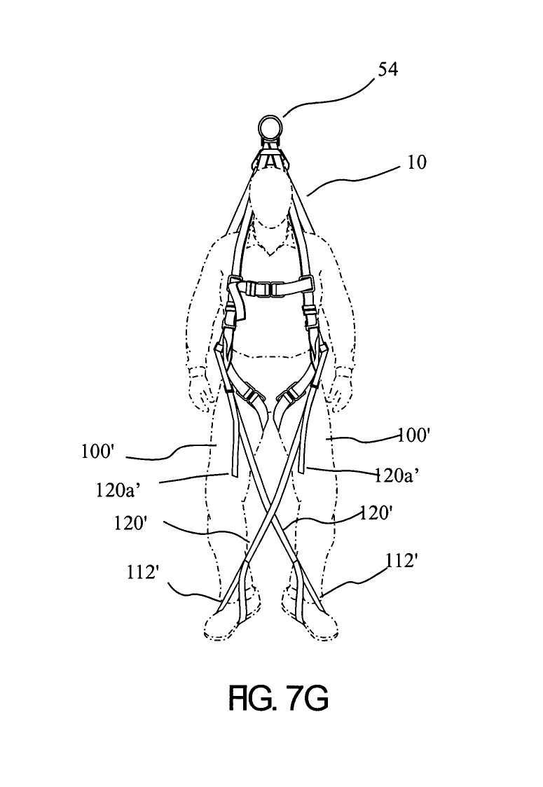

In addition to the manual deployment of foothold system 100 discussed above, foothold system 100 can deploy automatically in the case of a fall. In that regard, for example, a portion of the force of the fall can be transferred to the foot loop end of extending strap 120 or to sleeve 160 to extend, remove or unfold extending strap 120 and foot loop 110 from sleeve 160. This result can, for example, be accomplished by attaching an actuator (for example, an actuating line 167) to the foot loop end of foothold system 100 or to sleeve 160 as illustrated in FIG. 7B. Actuating line 167 can, for example, be connected to, for example, a shock absorbing lanyard, a self retracting lifeline 300 (see FIG. 7B) or another energy absorbing device to which safety harness 10 is connected or to a portion (for example, to D-ring 54) of safety harness 10 in a manner that, during a fall arrest, sufficient force is applied to foothold system 100 to cause deployment of foothold system 100. Other actuating devices (which can, for example, be energy assisted) can also be used to cause deployment of foothold system 100. Sleeve 160 can, for example, be caused to open in the case of a fall. An example of a lanyard 300 suitable for use with the safety harnesses of the present invention is the MILLER MIGHTYLITE® self-retracting lifeline, available from Bacou-Dalloz Fall Protection of Franklin, Pa. The manufacture and operation of a self retracting lanyard is described, for example, U.S. Pat. No. 5,771,993, assigned to the assignee of the present invention, the disclosure of which is incorporated herein by reference.

As illustrated in FIGS. 1B and 1E, foothold system 100 can, for example, be attached to harness 10 (via attaching member or loop 140) by passing foothold systems 100 through loops 34b and 24b formed in safety harness 10 as described above, and then doubling back the foot loop end of foothold system 100 through attaching loop 140. One skilled in the art will recognize, however, that the foothold systems of the present invention can be attached to safety harness 10 and other safety harness at a variety of positions thereon and in using a variety of attachment members/techniques.

FIG. 2 illustrates a user wearing safety harness 10 with left and right foothold systems 100 attached thereto. In this embodiment, foothold systems 100 are attached to back straps 22 and 32 using attachment loop 140 in a manner similar to that described above. In FIGS. 3 and 4 the user is suspended in harness 10 via D-ring anchor attachment 54 after a simulated fall. In FIGS. 3 and 4, the user has deployed/extended foothold systems 100 for used. The users feet are in foot loops/stirrups 110 and the length of extending strap 120 has been adjusted to accommodate the length of the users legs. In FIG. 3, the user is in a crouched position, while in FIG. 4 the user has extended his legs by pushing on foot loops 110 to place the user in an upright or standing position. By periodically pushing against foot loops 110 to achieve the upright or standing position of FIG. 4, the user can reduce the likelihood or prevent orthostatic intolerance/suspension trauma.

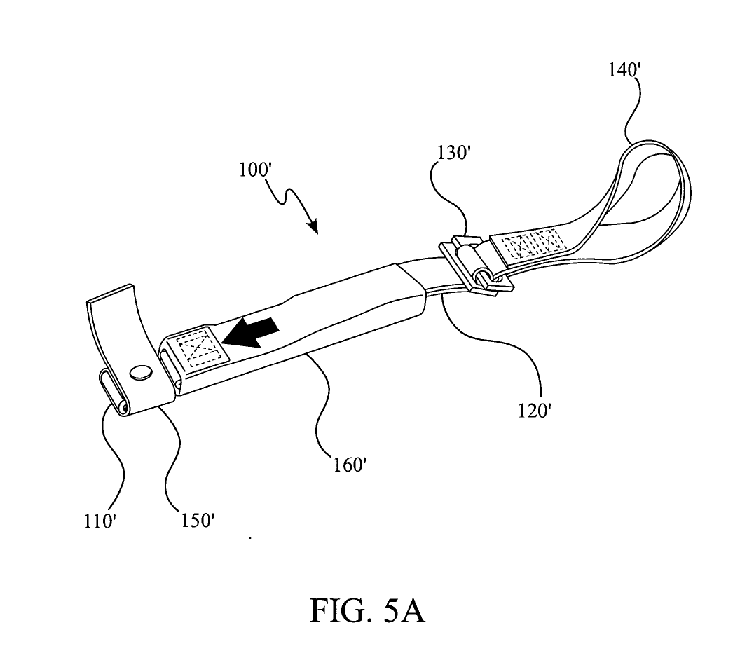

FIGS. 5A through 7G illustrate another embodiment of a foothold system 100′, which is similar in design and operation to foothold system 100. Components of foothold system 100, which are like in design and operation to corresponding components of foothold system 100, are numbered similarly to such corresponding components of foothold system 100, with the addition of a “′” designation. In that regard, foothold system 100′ includes a foot loop or stirrup 110′ in which the user of foothold system 100′ places the user's foot in the case of suspension after a fall. Foot loop 110′ is attached to (or is formed integrally with) an extending length of generally inelastic strapping material 120′ that is preferably adjustable in length via, for example, a buckle system 130′. Like foothold system 100, foothold system 100′ is preferably attachable to existing safety harnesses via an attachment member 140′, which in the embodiment of FIGS. 5A through 7G is a simple loop of material through which the opposite end of foothold system 100′ is looped, doubled back or passed through to attach foothold system 100′ to a safety harness.

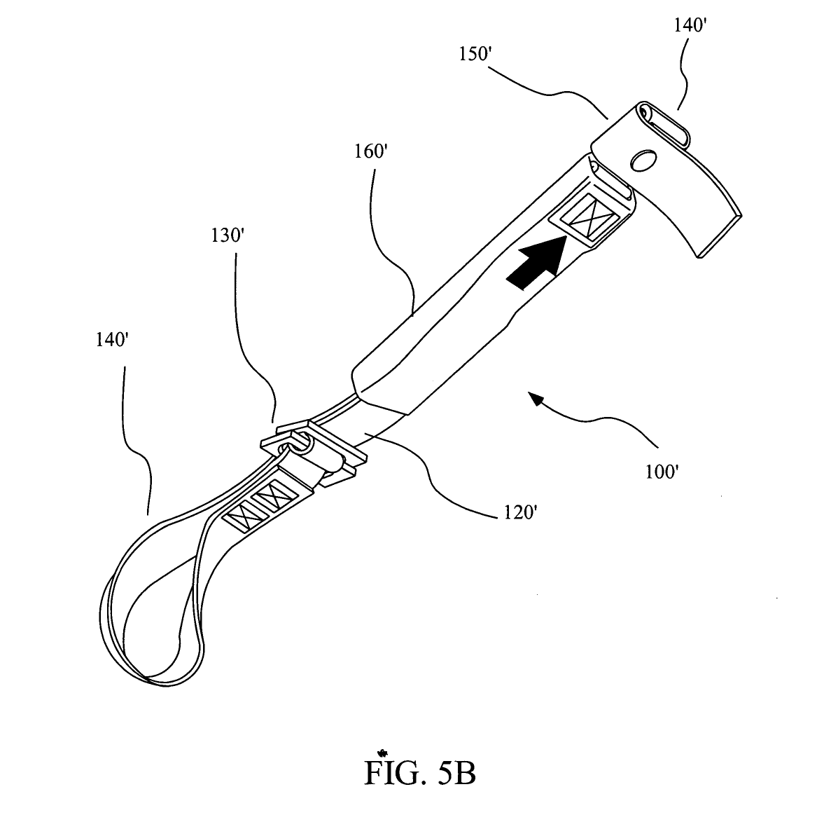

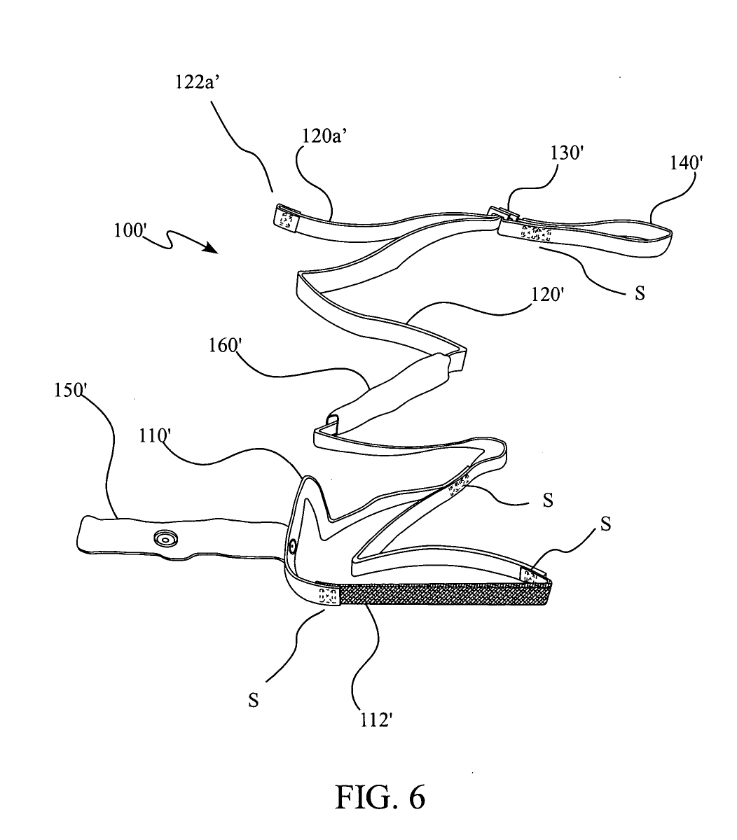

As illustrated in FIG. 6, various portions of foothold system 100′ are connected via stitching sections S (for example, an automatic box tack as known in the stitching art). As also illustrated in FIGS. 6, strap end 120a′ can include an end tab 122a′ to facilitate holding or grasping of strap end 120a′ and adjustment of the length of extending strap 120′. Ending tab 122a′ can, for example, be fluorescent, include fluorescent markings or otherwise visually enhanced to facilitate location thereof by the user. Likewise, an extending portion 112′ of foot loop 110′ can be fluorescent or otherwise visually enhanced to facilitate location thereof by the user (for example, in relatively low light situations).

Prior to deployment after a fall, foothold system 100′ is preferably compact and does not dangle away from a safety harness such as safety harness 10 (see, FIGS. 7A through 7G). Foothold system 100′ can, for example, include at least one snap fastener 150′ (for example, near the foot loop end thereof) to maintain foothold system 100′ in close connection with a strap of safety harness 10′ before deployment of foothold system 100′. To deploy foothold system 100′, snap fasteners 150′ is simply disconnected or unsnapped to allow foothold system 100′ to swing away from the strap of safety harness 10′ about attachment loop 140′. Foothold system 100′ further includes a storage sleeve 160′ in which at least a portion of foothold system 100′ is folded or otherwise compacted (see, for example, FIGS. 6A and 6B illustrating an accordion-like folding of foothold system 100′) before deployment of foothold system 100′. In one embodiment storage sleeve 160 was formed using transparent polymeric shrink tubing. During deployment of foothold system 100′, the user can, for example, simply pull the foot loop end of extending strap 120′ to extend, remove or unfold extending strap 120′ and foot loop 110′ from sleeve 160′. The user can, pull on end 120a′ to adjust the length of extending strap 120′ (via buckle 130′) to accommodate the length of the user's legs.

FIG. 7A illustrates foothold system 100′ in its compacted state attached to a back strap 22′ of a harness 10 while the user is standing on a surface. In FIG. 7B, the user is suspended in harness 20′ after a fall. FIGS. 7C and 7D illustrate deployment of foothold system 100′, wherein the user simply holds the foot loop end of foothold system 100′ and pulls to extend or unfold the portion of foothold system 100′ folded within sleeve 160′. FIGS. 7E through 7G illustrate placement of the user's feet within foot loops 110′. In FIGS. 7E through 7G, the user is illustrated to have “crossed” foothold systems 100′ so that foothold system 100′ attached to the right side of harness 10′ is used by the left foot/leg of the user, while foothold system 100′ attached to the left side of harness 10′ is used by the right foot/leg of the user. Crossing the foothold systems of the present invention can increase ease of use thereof and increase the comfort of the user by, for example, helping the user to maintain his or her legs directly beneath the user's torso and enabling a more erect stance when extending the user's legs. FIG. 7G illustrates the user in position to extend and bend the user's legs while within foothold systems 100 and 100′ to prevent suspension trauma.

In the representative embodiments of the present invention, a foothold system of the present invention is attached to each lateral side of a safety harness. However, a single foothold system can be attached to a safety harness (or other fall protection device) and suffice to reduce the likelihood or to prevent suspension trauma. For example, the user can alternate the foot positioned within the foot loop of the foothold system. The user can alternatively place both feet in a single foot loop or stirrup (in, for example, either a crossed or uncrossed configuration). Further, the user can place one foot in a foot loop of a foothold system of the present invention and place the other foot on top of that foot in extending and bending the user's legs during suspension.

The foregoing description and accompanying drawings set forth preferred embodiments of the invention at the present time. Various modifications, additions and alternative designs will, of course, become apparent to those skilled in the art in light of the foregoing teachings without departing from the scope of the invention. The scope of the invention is indicated by the following claims rather than by the foregoing description. All changes and variations that fall within the meaning and range of equivalency of the claims are to be embraced within their scope.

1. A foothold system for attachment to a fall protection device, comprising:
at least one foot seating upon which a user can rest at least one foot; and
at least one attachment member in operative connection with the foot seating, the attachment member being adapted to attach to the fall protection device.

2. The foothold system of claim 1 wherein the attachment member. is a loop attached at an end of the foothold system through which the foot loop can be doubled back.

3. The foothold system of claim 1 wherein the attachment member is a adapted to attach a fall protection safety harness after manufacture of the safety harness is complete.

4. The foothold system of claim 3 wherein the attachment member is a loop attached at an end thereof through which the foot loop can be doubled back.

5. The foothold system of claim 1 wherein a distance between the attachment member and a bottom of the foot seating is adjustable.

6. The foothold system of claim 1 wherein the foothold system further comprises an extending strap attached to the attachment member and the foot seating is a foot loop attached at an end of the extending strap opposite the attachment member.

7. The foothold system of claim 5 wherein the length of the extending strap between the attachment member and the foot loop is adjustable.

8. The foothold system of claim 7 wherein the wherein the length of the strap is adjustable via a buckle mechanism.

9. The foothold system of claim 6 wherein the attachment member is a adapted to attach a fall protection safety harness after manufacture of the safety harness is complete.

10. The foothold system of claim 6 wherein the attachment member is a loop through which the foot loop and extending strap can be doubled back.

11. The foothold system of claim 1 wherein at least a portion of the foothold system is compacted to reduce the overall size of the foothold system prior to deployment of the foothold system.

12. The foothold system of claim 11 further comprising a container into which at least a portion of the foothold system is compacted.

13. The foothold system of claim 6 wherein at least a portion of the foothold system is compacted to reduce the overall size of the foothold system prior to deployment of the foothold system.

14. The foothold system of claim 13 further comprising a container into which a portion of the extending strap and the foot loop are compacted.

15. The foothold system of claim 13 further comprising at least one retaining strap to hold the foothold system in close proximity to a strap of the safety harness prior to deployment of the foothold system.

16. A safety harness system comprising:
a safety harness comprising at least one strap portion for extending over a portion of the person's body to retain the person within the safety harness; and
at least one foothold system, the foothold system comprising:
at least one foot seating upon which a user can rest at least one foot; and
at least one attachment member in operative connection with the foot seating, the attachment member being adapted to attach to the safety harness.

17. The safety harness of claim 16 wherein the attachment member is a loop attached at an end of the foothold system through which the foot loop can be doubled back.

18. The safety harness system of claim 16 wherein the attachment member is a adapted to attach a fall protection safety harness after manufacture of the safety harness is complete.

19. The safety harness system of claim 18 wherein the attachment member is a loop attached at an end thereof through which the foot loop can be doubled back.

20. The safety harness system of claim 16 wherein a distance between the attachment member and a bottom of the foot seating is adjustable.

21. The safety harness system of claim 16 wherein the foothold system further comprises an extending strap attached to the attachment member and the foot seating is a foot loop attached at an end of the extending strap opposite the attachment member.

22. The safety harness system of claim 21 wherein the length of the strap between the attachment member and the foot loop is adjustable.

23. The safety harness system of claim 22 wherein the length of the strap is adjustable via a buckle mechanism.

24. The safety harness system of claim 21 wherein the attachment member is a adapted to attach a safety harness after manufacture of the safety harness is complete.

25. The safety harness system of claim 24 wherein the attachment member is a loop through which the foot loop and extending strap can be doubled back.

26. The safety harness system of claim 16 wherein at least a portion of the foothold system is compacted to reduce the overall size of the foothold system prior to deployment of the foothold system.

27. The safety harness system of claim 26 wherein the foothold system further comprises a container into which at least a portion of the foothold system is compacted.

28. The safety harness system of claim 21 wherein at least a portion of the foothold system is compacted to reduce the overall size of the foothold system prior to deployment of the foothold system.

29. The foothold system of claim 28 further comprising a container into which a portion of the extending strap and the foot loop are compacted.

30. The safety harness system of claim 29 wherein the foothold system further comprises at least one retaining strap to hold the foothold system in close proximity to the strap portion of the safety harness prior to deployment of the foothold system.

31. A method of incorporating a foothold system into a fall protection device, comprising the step:
attaching the foothold system to the fall protection device after manufacture of the fall protection device is complete.

32. The method of claim 31 wherein at least a portion of the foothold system is in a compacted state prior to deployment after a fall.

33. The method of claim 32 wherein the portion of the foothold system is compacted within a container.

34. The method of claim 31 wherein the foothold system comprises:
at least one foot seating upon which a user can rest at least one foot; and
at least one attachment member in operative connection with the foot seating, the attachment member being adapted to attach to the fall protection device;
and wherein the fall protection device is a safety harness which comprises at least one strap portion for extending over a portion of the person's body to retain the person within the safety harness.

35. The method of claim 34 wherein the attachment member is a loop attached at an end of the foothold system through which the foot loop can be doubled back.

36. The method of claim 34 wherein a distance between the attachment member and a bottom of the foot seating is adjustable.

37. The method of claim 31 wherein the a foothold system comprises:
a foot seating upon which a user can rest at least one foot;
an extending strap attached to the foot seating; and
an attachment member attached to the extending strap at a spaced distance from the foot seating, the attachment member being adapted to attach to the safety harness;
and wherein the fall protection device is a safety harness which comprises at least one strap portion for extending over a portion of the person's body to retain the person within the safety harness.

38. The method of claim 37 wherein the attachment member is an attachment loop and the step of attaching the foothold system to the strap includes the step of passing the foot loop and extending strap through the attachment loop.

39. The method of claim 31 wherein two of the foothold systems are attached to the fall protection device.

40. A fall protection system comprising:
a fall protection device used to suspend a user in the case of a fall; and
at least one foothold system, the foothold system comprising:
a foot seating into which a user can insert a foot; and
an attachment member in operative connection with the foot seating, the attachment member being adapted to attach to the fall protection device.

41. A method of facilitating leg movement of a person suspended in a fall protection harness, comprising:
deploying a foothold system attached to the fall protection harness from a compacted state to an uncompacted state after a fall; and
placing at least one foot of the person into a foot seating of the foothold system after deployment of the foothold system.

42. The method of claim 41 further comprising the step of attaching the foothold system to the fall protection harness before the fall.

43. The method of claim 42 wherein the foothold system is attached to the safety harness using an attachment member comprising a loop attached at an end of the foothold system through which at least a portion of the foothold system can be doubled back.

44. A fall protection system comprising:
a fall protection device used to suspend a user in the case of a fall; and
at least one foothold system, the foothold system comprising:
a foot seating into which a user can insert a foot; and
an attachment member in operative connection with the foot seating, the attachment member being adapted to attach to the fall protection device; the foothold system being adapted to be compacted to reduce the overall size thereof.
